(19) United States
(12) Patent Application Publication
(10) Pub. No.: US 2026/0127408 A1
(43) Pub. Date: May 7, 2026

(54) COMPUTING SYSTEMS AND METHODS FOR AUTOMATICALLY COMPUTING ACCURACY OF A LARGE LANGUAGE MODEL

(71) Applicant: The Toronto-Dominion Bank, Toronto (CA)

(72) Inventors: Marc MAHE, Halifax (CA); Dino VITALE, Glen Ridge, NJ (US); Behrooz Heshmaty, Basking Ridge, NJ (US)

(21) Appl. No.: 18/935,300

(22) Filed: Nov. 1, 2024

(51) Int. Cl. G06N 3/006

(52) U.S. Cl. CPC G06N 3/006

(57) ABSTRACT

An artificial intelligence computing tool is provided for automatically evaluating an operating large language model (LLM) against a benchmark LLM for integration into an application. The benchmark LLM is used to compute a benchmark question and a benchmark answer per portion of text data from amongst a plurality of portions of text data. The plurality of benchmark questions and the plurality of portions of text data are inputted into the operating LLM to compute a plurality of comparative answers that respectively correspond to the plurality of benchmark questions and respectively correspond to the plurality of portions of text data. Benchmark answers are compared with respective comparative answers to output correctness values. The correctness values associated with the plurality of benchmark questions are used to compute an accuracy score of the operating LLM. In some cases, the operating LLM is smaller than the benchmark LLM.

### TECHNICAL FIELD

The disclosed exemplary embodiments relate to computer-implemented systems and methods for automatically evaluating accuracies of large language models (LLMs).

### BACKGROUND

Large Language Models (LLMs) are becoming more commonly used for interactive chatbots. It is recognized that there are many different types of LLMs. Some LLMs require more computational resources (e.g., processing time, processing capability, and memory), while some LLMs require less computational resources. In some cases, smaller LLMs that require less computational resources are less accurate compared to larger LLMs that require more computational resources. In some cases, smaller LLMs are sometimes desired, but may come with the associated trade-off with having less accuracy.

### SUMMARY

The following summary is intended to introduce the reader to various aspects of the detailed description, but not to define or delimit any invention.

In at least one broad aspect, there is provided a server system for evaluating an operating large language model (LLM). The server system comprises: a memory storing at least a benchmark LLM and the operating LLM, a network interface, and a processor. The processor is operably coupled to the memory and the network interface. The processor is configured to at least: obtain a plurality of portions of text data; use the benchmark LLM to compute at least one benchmark question and one benchmark answer per portion of text data from amongst the plurality of portions of text data, and store a plurality of benchmark questions and a plurality of benchmark answers respectively in association with the plurality of portions of text data; input the plurality of benchmark questions and the plurality of portions of text data into the operating LLM to compute a plurality of comparative answers that respectively correspond to the plurality of benchmark questions and respectively correspond to the plurality of portions of text data; for each one of the plurality of benchmark questions, compare a respective benchmark answer from amongst the plurality of benchmark answers and a respective comparative answer from amongst the plurality of comparative answers to output a correctness value; and compute and output an accuracy score of the operating LLM based on a combination of a plurality of correctness values associated with the plurality of benchmark questions.

In some cases, the plurality of portions of text data are from a group of documents, and the group of documents is associated with an interactive chat knowledge application.

In some cases, after determining that the accuracy score of the operating LLM is above a threshold score, automatically integrating the operating LLM in the interactive chat knowledge application; and wherein the interactive chat knowledge application comprises: a chatbot user interface, the operating LLM, and a database comprising the group of documents.

In some cases, when the operating LLM has been automatically integrated into the interactive chat knowledge application, the processor is further configured to at least: receive a user-inputted question via the chatbot interface; process the user-inputted question using the operating LLM to output a response derived from one or more documents from the group of documents; and display, via the chatbot interface, the response and one or more citations corresponding to the one or more documents.

In some cases, a plurality of operating LLMs are automatically evaluated against the benchmark LLM, and the processor is further configured to at least: identify a given operating LLM with a highest accuracy score from amongst the plurality of operating LLMs, and automatically integrate the given operating LLM into the interactive chat knowledge application. The interactive chat knowledge application comprises: a chatbot user interface, the operating LLM, and a database comprising the group of documents.

In some cases, the benchmark LLM is larger than the operating LLM.

In some cases, a comparator LLM is used to compare the respective benchmark answer from amongst the plurality of benchmark answers and the respective comparative answer from amongst the plurality of comparative answers to output the plurality of correctness values.

In some cases, the comparator LLM is the benchmark LLM.

In some cases, the comparator LLM is a secondary benchmark LLM that is more accurate than the operating LLM.

In some cases, the correctness value is one of a correct value or an incorrect value, and the accuracy score is computed by: a number of correct values divided by a number of the plurality of benchmark questions.

In at least another broad aspect, a method for evaluating an operating large language model (LLM) is provided. The method is executed in a computing environment comprising one or more processors and memory, wherein the memory stores at least a benchmark LLM and the operating LLM. The method comprising: obtaining a plurality of portions of text data; using the benchmark LLM to compute at least one benchmark question and one benchmark answer per portion of text data from amongst the plurality of portions of text data, and storing a plurality of benchmark questions and a plurality of benchmark answers respectively in association with the plurality of portions of text data; inputting the plurality of benchmark questions and the plurality of portions of text data into the operating LLM to compute a plurality of comparative answers that respectively correspond to the plurality of benchmark questions and respectively correspond to the plurality of portions of text data; for each one of the plurality of benchmark questions, comparing a respective benchmark answer from amongst the plurality of benchmark answers and a respective comparative answer from amongst the plurality of comparative answers to output a correctness value; and computing and outputting an accuracy score of the operating LLM based on a combination of a plurality of correctness values associated with the plurality of benchmark questions.

In some cases, the plurality of portions of text data are from a group of documents, and the group of documents is associated with an interactive chat knowledge application.

In some cases, after determining that the accuracy score of the operating LLM is above a threshold score, the method further comprises automatically integrating the operating LLM in the interactive chat knowledge application. The interactive chat knowledge application comprises: a chatbot user interface, the operating LLM, and a database comprising the group of documents.

In some cases, when the operating LLM has been automatically integrated into the interactive chat knowledge application, the method further comprises: receiving a user-inputted question via the chatbot interface; processing the user-inputted question using the operating LLM to output a response derived from one or more documents from the group of documents; and displaying, via the chatbot interface, the response and one or more citations corresponding to the one or more documents.

In some cases, a plurality of operating LLMs are automatically evaluated against the benchmark LLM, and the method further comprises: identifying a given operating LLM with a highest accuracy score from amongst the plurality of operating LLMs, and automatically integrating the given operating LLM into the interactive chat knowledge application. The interactive chat knowledge application comprises: a chatbot user interface, the operating LLM, and a database comprising the group of documents.

In some cases, the benchmark LLM is larger than the operating LLM.

In some cases, a comparator LLM is used to compare the respective benchmark answer from amongst the plurality of benchmark answers and the respective comparative answer from amongst the plurality of comparative answers to output the plurality of correctness values.

In some cases, the comparator LLM is a secondary benchmark LLM that is more accurate than the operating LLM.

In some cases, the correctness value is one of a correct value or an incorrect value, and the accuracy score is computed by: a number of correct values divided by a number of the plurality of benchmark questions.

According to some aspects, the present disclosure provides a non-transitory computer-readable medium storing computer-executable instructions. The computer-executable instructions, when executed, configure a processor to perform any of the methods described herein.

### BRIEF DESCRIPTION OF THE DRAWINGS

The drawings included herewith are for illustrating various examples of articles, methods, and systems of the present specification and are not intended to limit the scope of what is taught in any way. In the drawings:

FIG. 1A is a schematic block diagram of a system for processing application requests in accordance with at least some embodiments;

FIG. 1B is a schematic block diagram of a cloud-based computing cluster of FIG. 1A, including an application configured to evaluate an operating LLM, in accordance with at least some embodiments;

FIG. 2 is a block diagram of a computer in accordance with at least some embodiments;

FIG. 3 is a schematic block diagram of another cloud-based computing cluster of FIG. 1A, including an application configured to evaluate an operating LLM, in accordance with at least some embodiments;

FIG. 4 is a flowchart diagram of an example method for automatically computing accuracy of an operating LLM, in accordance with at least some embodiments; and

FIG. 5 is a flowchart diagram of an example method for automatically computing accuracies of a plurality of operating LLMs and automatically integrating a given LLM with a highest accuracy into an interactive chat knowledge application, in accordance with at least some embodiments.

### DETAILED DESCRIPTION

In some cases, evaluating LLMs is difficult, since LLMs continue to be updated and the appropriateness of an LLM may vary between use-cases and datasets. In some cases, a computing system is provided herein to automatically evaluate if a smaller LLM is sufficiently suitable for an intended application.

In some cases, large LLMs have more parameters than smaller LLMs, which have less parameters. In some cases, large LLMs have more than double the number of parameters than a smaller LLM. In some other cases, large LLMs have more than five times the number of parameters than a smaller LLM. In some other cases, large LLMs have more than ten times the number of parameters than a smaller LLM. In some cases, a computing system is provided herein to automatically evaluate if a smaller LLM is sufficiently suitable for an intended application.

In some cases, a server system and a method are provided for automatically evaluating an operating LLM against a benchmark LLM. The benchmark LLM is used to generate benchmark questions and benchmark answers for a dataset, an operating LLM is used to generate comparative answers for the same dataset, and an accuracy score is computed by comparing the comparative answers against the benchmark answers.

In some cases, the server system quickly and automatically evaluates an operating LLM in comparison with a benchmark LLM to determine if the operating LLM could be used in an application. In some cases, the benchmark LLM is a larger LLM that uses more computational resources compared to an operating LLM. In some cases, the server system uses an artificial intelligence (Al) driven tool to automatically evaluate the operating LLM against a benchmark LLM by comparing answers for a same dataset. If an accuracy score of the smaller operating LLM meets a certain condition, then the smaller LLM is integrated into the application. In some cases, when the smaller operating LLM is integrated into the application, the computational resources and processing time for using the application, which runs the smaller operating LLM, are reduced compared to running the benchmark LLM.

In some cases, a chatbot is trained using a group of documents, so that the chatbot is considered an expert on the information contained in the group of documents. It is desirable to evaluate a potential operating LLM that can be used to drive the chatbot for an interactive knowledge application.

In some cases, the group of documents are used to generate a plurality of portions of text data. In some cases, a given document (from amongst the group of documents) is divided into a plurality of portions of text data, and these portions of text data overlap each other. For example, a document has 10,000 words, and each portion of data includes 1000 words with overlap of 200 words between consecutive portions of data. This pre-processing of the documents is also referred to as chunking text, which results in chunks of text data.

In some cases, the benchmark LLM is used to process each portion of text data to generate a question and corresponding answer, similar to a testing question and answer key. This is also referred to as a benchmark question and a benchmark answer. The benchmark question and benchmark answer are stored in association with the related portion of text data. The server system stores the plurality of benchmark questions and the plurality of benchmark answers respectively in association with the plurality of portions of text data.

In some cases, the operating LLM is evaluated by then inputting the plurality of benchmark questions and corresponding plurality of portions of text data into the operating LLM. This results in the operating LLM computing and outputting a plurality of comparative answers that respectively correspond to the plurality of benchmark questions.

In some cases, for each one of the plurality of benchmark questions, a comparator LLM compares a respective benchmark answer and a respective comparative answer to output a correctness value. In some cases, the correctness value is binary (i.e., representing correct or incorrect). In some other cases, a numerical percentage (e.g., between 0 and 1) is used to score the correctness value.

The entirety of the correctness values, corresponding to the plurality of the comparative answers, is used to compute and output an accuracy score of the operating LLM. For example, there are 1000 portions text data; 1000 benchmark questions; 1000 benchmarks answers; 1000 comparative answers; and 1000 correctness values. Of the 1000 correctness values, there are 900 correct values and 100 incorrect values. The accuracy score of the operating LLM is then 90%.

In some cases, after an operating LLM is considered to pass a threshold of accuracy resulting from the evaluation, then the operating LLM is automatically integrated into the interactive chat knowledge application, which includes: the chatbot, a database comprising the group of documents, and the operating LLM.

In some cases, multiple potential operating LLMs are evaluated against the benchmark LLM using the process described above, and the potential operating LLM with the highest accuracy score is automatically integrated into the interactive chat knowledge application.

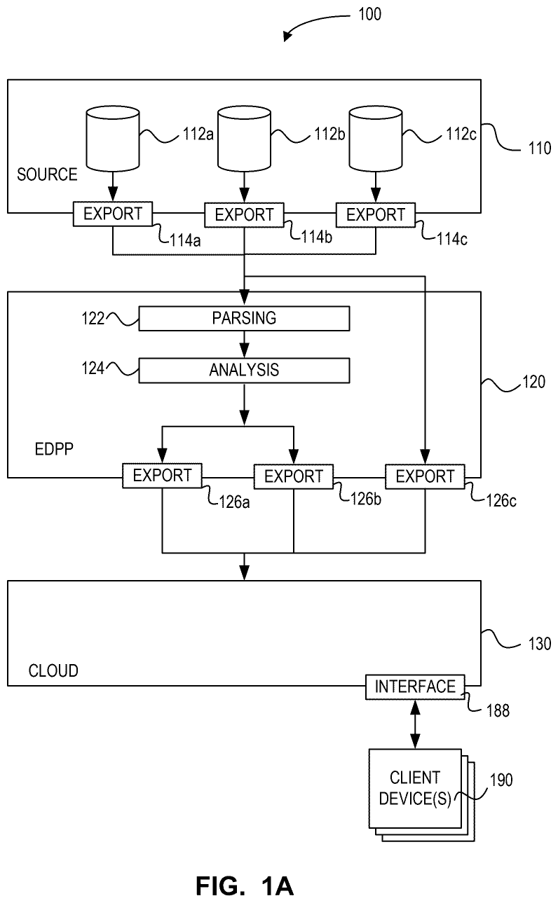

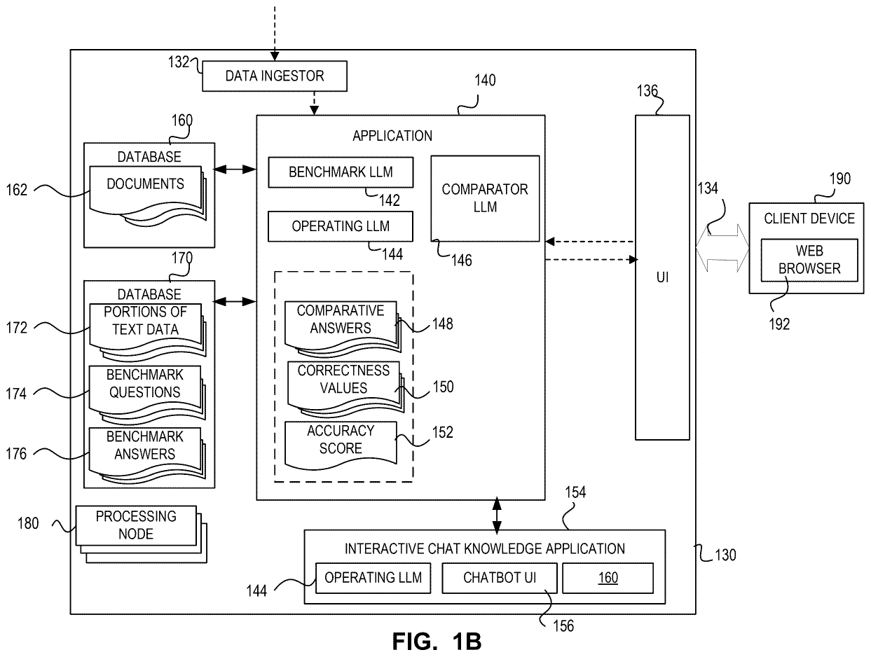

Referring now to FIG. 1A, there is illustrated a block diagram of an example computing system, in accordance with at least some embodiments. Computing system 100 has a source database system 110, an enterprise data provisioning platform (EDPP) 120 operatively coupled to the source database system 110, and a cloud-based computing cluster 130 that is operatively coupled to the EDPP 120. In some cases. this computing system 100 is provided for automated data processing of large data sets, including computing a time series of predicted characteristics of assets identified within the large data sets.

Source database system 110 has one or more databases, of which three are shown for illustrative purposes: database 112a, database 112b and database 112c. One or more the databases of the source database system 110 may contain confidential information that is subject to restrictions on export. One or more export modules 114a, 114b, 114c may periodically (e.g., daily, weekly, monthly, etc.) export data from the databases 112a, 112b, 112c to EDPP 120. In some instances, the data is exported on an ad hoc basis. In some cases, the export data may be exported in the form of comma separated value (CSV) data, however other formats may also be used.

EDPP 120 receives source data exported by the export modules 114 of source database system 110, processes it and exports the processed data to an application database within the cloud-based computing cluster 130. For example, a parsing module 122 of EDPP 120 may perform extract, transform and load (ETL) operations on the received source data.

In many environments, access to the EDPP may be restricted to relatively few users, such as administrative users. However, with appropriate access permissions, data relevant to an application or group of applications (e.g., a client application) may be exported via reporting and analysis module 124 or an export module 126. In particular, parsed data can then be processed and transmitted to the cloud-based computing cluster 130 by a reporting and analysis module 124. Alternatively, one or more export modules 126a, 126b, 126c can export the parsed data to the cloud-based computing cluster 130.

In some cases, there may be confidentiality and privacy restrictions imposed by governmental, regulatory, or other entities on the use or distribution of the source data. These restrictions may prohibit confidential data from being transmitted to computing systems that are not “on-premises” or within the exclusive control of an organization, for example, or that are shared among multiple organizations, as is common in a cloud-based environment. In particular, such privacy restrictions may prohibit the confidential data from being transmitted to distributed or cloud-based computing systems, where it can be processed by machine learning systems, without appropriate anonymization or obfuscation of personal identifiable information (PII) in the confidential data. Moreover, such “on-premises” systems typically are designed with access controls to limit access to the data, and thus may not be resourced or otherwise suitable for use in broader dissemination of the data. In some cases, to comply with such restrictions, one or more module of EDPP 120 may “de-risk” data tables that contain confidential data prior to transmission to cloud-based computing cluster 130. In some cases, this de-risking process may obfuscate or mask elements of confidential data, or may exclude certain elements, depending on the specific restrictions applicable to the confidential data. The specific type of obfuscation, masking or other processing is referred to as a “data treatment.”

The cloud-based computing cluster 130 includes an interface 188, which facilitates data communication with one or more client devices.

Referring now to FIG. 1B, there is illustrated a block diagram of the cloud-based computing cluster 130, showing greater detail of the elements of the cloud-based computing cluster, which may be implemented by computing nodes of the cluster that are operatively coupled.

The components of the cloud-based computing cluster 130 include a data ingestor 132, an application 140, a user interface (UI) 136 for the application 140, a documents database 160 storing a plurality of documents 162, and a benchmark database 170 storing data computed by a benchmark LLM 142. In some cases, the components of the cloud-based cluster 130 are implemented as one or more processing nodes 180. In some cases, these components are implemented as virtual machines within the cloud-based computing cluster.

In some cases, the application 140 is a tool for automatically evaluation one or more operating LLMs for integration into another application, such as an interactive chat knowledge application 154. In some cases, the application 140 includes a benchmark LLM 142 and an operating LLM 144. In some cases, the benchmark LLM 142, or another pre-processing module, identifies a plurality of portions of text data 172 (also called chunks) from one or more the documents 162. The benchmark LLM compute at least one benchmark question and one benchmark answer per portion of text data from amongst the plurality of portions of text data. This generates a plurality of benchmark questions 174 and a plurality of benchmark answers 176 respectively in association with the plurality of portions of text data 172. In some cases, this information derived from the benchmark LLM is stored in the benchmark database 170.

In some cases, the plurality of benchmark questions 174 and the plurality of portions of text data 172 are inputted into the operating LLM 144 to compute a plurality of comparative answers 148 that respectively correspond to the plurality of benchmark questions 174 and respectively correspond to the plurality of portions of text data 172. For each one of the plurality of benchmark questions 174, the application 140 compares a respective benchmark answer from amongst the plurality of benchmark answers 176 and a respective comparative answer from amongst the plurality of comparative answers 148 to output a correctness value. In other words, there are a plurality of correctness values that have been computed that respectively correspond to the plurality of comparative answers 148. The combination of the plurality of correctness values 150 are used to compute and output an accuracy score 152 of the operating LLM 144.

In some cases, the application 140 includes a comparator LLM 146 that compares a respective benchmark answer and a respective comparative answer to output a correctness value.

In some cases, data from the data ingestor 132 is transmitted to the application 140, and data includes the documents 162. In some cases, an operating LLM 144 is transmitted to the application 140 via the data ingestor 132.

In some other cases, the documents 162 or the operating LLM 144 to be evaluated, or both, are transmitted to the application 140 via a UI 136, transmittable by a client device 190. The client device 190 includes a web browser 192 that communicates with the UI 136 via a communication link 134.

In some cases, when the operating LLM 144 is considered to be meet certain requirements by the application 140, the operating LLM 144 is automatically integrated into the interactive chat knowledge application 154. In some cases, the interactive chat knowledge application 154 includes the operating LLM 144, a chatbot UI 156, and the documents database 160 (or has access to the documents database 160).

In some cases, the interactive chat knowledge application 154 is configured to operate with a LLM, including sending prompts to the LLM and receives responses from the LLM. In some cases, the application 140 is configured with read and write access to the interactive chat knowledge application 154. In some cases, the application 140 automatically loads an operating LLM 144, which has been approved by the application 140, into the interactive chat knowledge application 154. After the operating LLM 144 is integrated into the interactive chat knowledge application 154, a user's interaction with the chatbot UI 156 invokes using the operating LLM 144 to generate responses. For example, a user will ask the chatbot UI 156 a question; the chatbot UI 156 generates a prompt for the operating LLM 144; the operating LLM 144 generates and returns a response that is derived from the documents in the documents database 160; and the chatbot UI 156 displays the response to the user.

In some cases, after the application 140 evaluates the operating LLM 144, the application 140 provides the accuracy score of the operating LLM 144 to the UI 136 for display to the client device 190. In some cases, the application 140 provides a message or data to the UI 136 indicating whether or not the operating LLM 144 has been approved for integration into the interactive chat knowledge application 154, and this is conveyed to the client device 190. In some cases, the application 140 provides a message or data to the UI 136 indicating whether or not the operating LLM 144 has been automatically integrated into the interactive chat knowledge application 154, and this is conveyed to the client device 190.

It will be appreciated that, while the components shown in FIG. 1B for the cloud-based computing cluster 130 can be implemented with the system 100 in FIG. 1A, in some other cases, the components shown in FIG. 1B are instead implemented in an isolated computing server system. In other words, the components shown in FIG. 1B can be implemented as a processing node 180 without the EDPP 120 and the source database system 110.

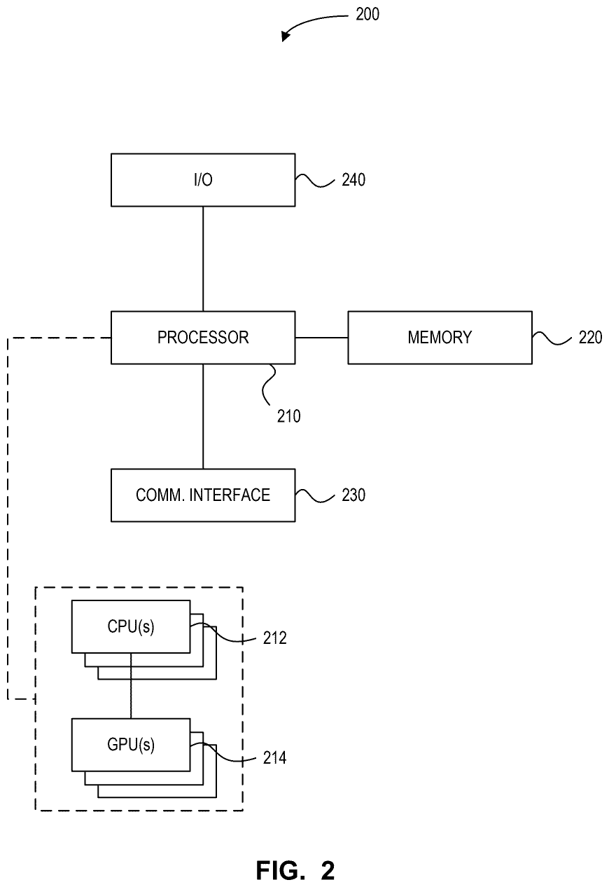

Referring now to FIG. 2, there is illustrated a simplified block diagram of a computer in accordance with at least some embodiments. Computer 200 is an example implementation of a computer such as source database system 110, EDPP 120, processing node 180 of FIGS. 1A and 1B. Computer 200 has at least one processor 210 operatively coupled to at least one memory 220, at least one communications interface 230 (also herein called a network interface), and at least one input/output device 240.

The at least one memory 220 includes a volatile memory that stores instructions executed or executable by processor 210, and input and output data used or generated during execution of the instructions. Memory 220 may also include non-volatile memory used to store input and/or output data—e.g., within a database—along with program code containing executable instructions.

Processor 210 may transmit or receive data via communications interface 230, and may also transmit or receive data via any additional input/output device 240 as appropriate.

In some cases, the processor 210 includes a system of central processing units (CPUs) 212. In some other cases, the processor includes a system of one or more CPUs and one or more Graphical Processing Units (GPUs) 214 that are coupled together. In some cases, the benchmark LLM, the operating LLM, and/or the comparator LLM execute neural network computations on CPU and GPU hardware, such as the system of CPUs 212 and GPUS 214.

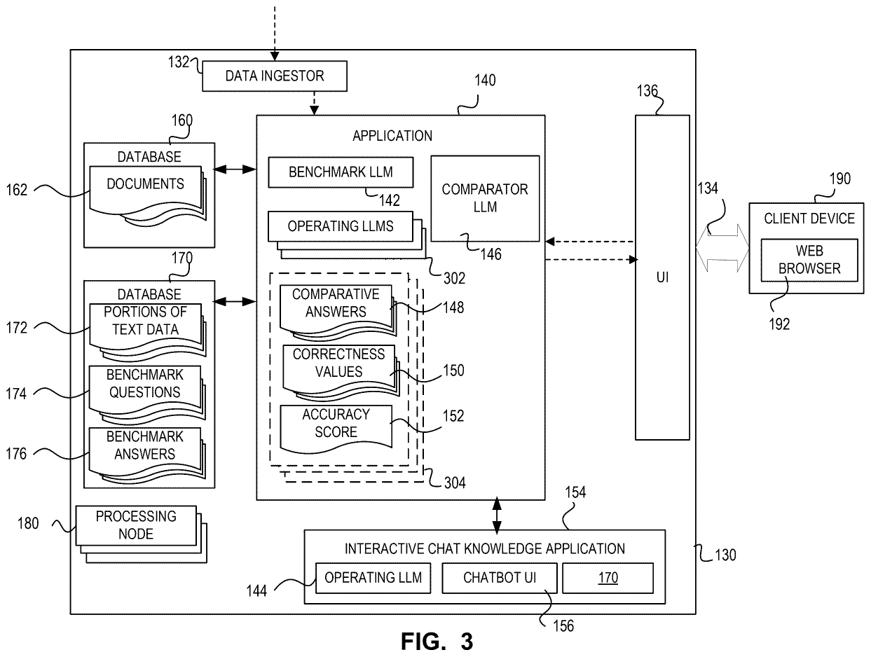

Referring now to FIG. 3, another example embodiment of the cloud-based computing cluster 130 is shown, but configured for evaluating a plurality of operating LLMs 302.

A plurality of operating LLMs 302 are evaluated against the benchmark LLM 142, which generates a plurality of comparative data sets 304 respectively associated with the plurality of operating LLMs 302. For example, a comparative data set that corresponds to a candidate operating LLM, includes a plurality of comparative answers 148, a plurality of correctness values 150, and an accuracy score 152. The candidate operating LLM with the highest accuracy score is automatically integrated into the interactive chat knowledge application 154.

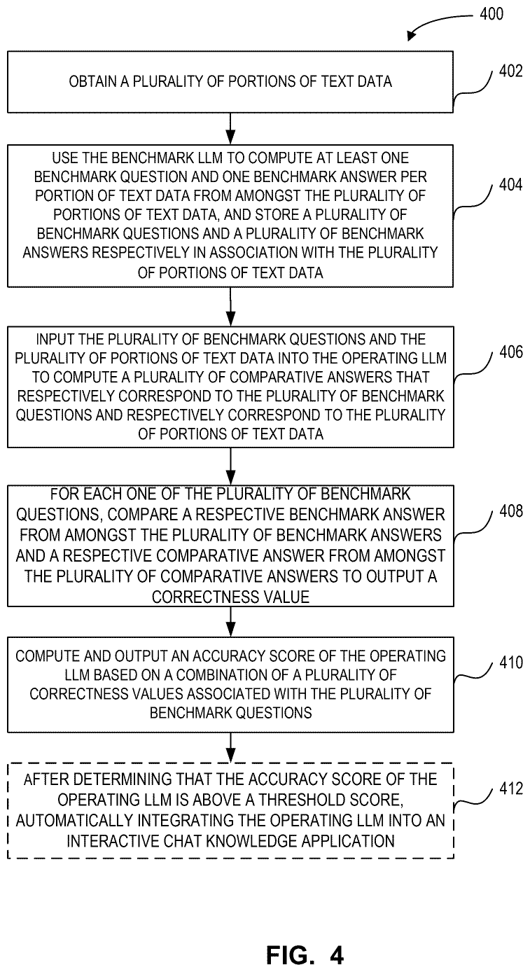

Referring now to FIG. 4, an example process 400 is provided which is executable by a processor.

Block 402: The processor obtains a plurality of portions of text data.

Block 404: The processor uses the benchmark LLM to compute at least one benchmark question and one benchmark answer per portion of text data from amongst the plurality of portions of text data, and stores a plurality of benchmark questions and a plurality of benchmark answers respectively in association with the plurality of portions of text data.

Block 406: The processor inputs the plurality of benchmark questions and the plurality of portions of text data into the operating LLM to compute a plurality of comparative answers that respectively correspond to the plurality of benchmark questions and respectively correspond to the plurality of portions of text data.

Block 408: The processor, for each one of the plurality of benchmark questions, compares a respective benchmark answer from amongst the plurality of benchmark answers and a respective comparative answer from amongst the plurality of comparative answers to output a correctness value.

Block 410: The processor computes and outputs an accuracy score of the operating LLM based on a combination of a plurality of correctness values associated with the plurality of benchmark questions.

In some cases, the processor automatically integrates the operating LLM.

Block 412: After determining that the accuracy score of the operating LLM is above a threshold score, the processor automatically integrates the operating LLM into an interactive chat knowledge application.

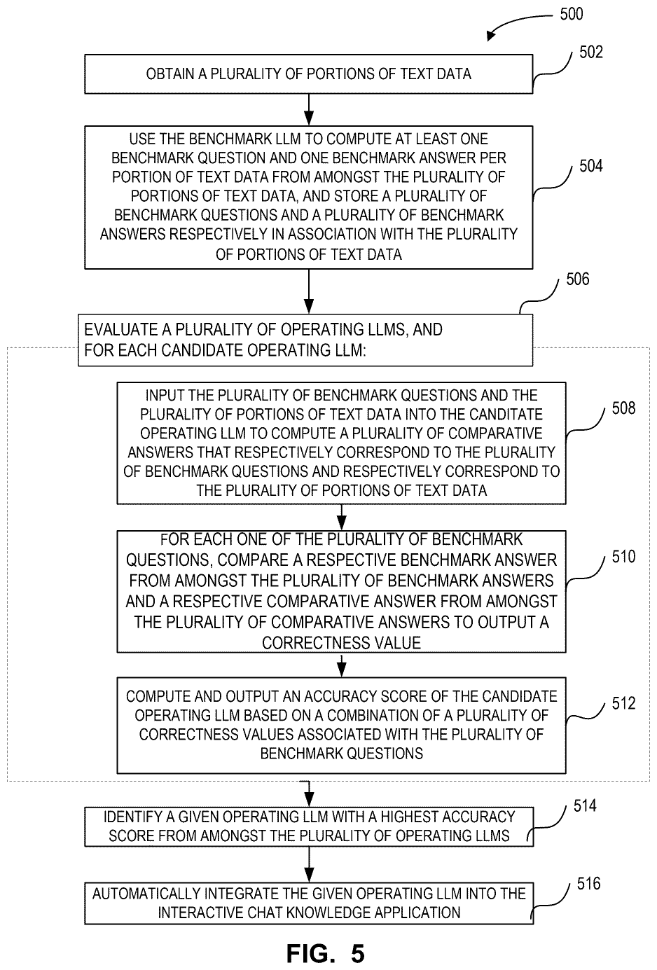

Referring now to FIG. 5, an example process 500 is provided which is executable by a processor. The process 500 is used to evaluate a plurality of candidate operating LLMs.

Block 502: The processor obtains a plurality of portions of text data.

Block 504: The processor uses the benchmark LLM to compute at least one benchmark question and one benchmark answer per portion of text data from amongst the plurality of portions of text data, and stores a plurality of benchmark questions and a plurality of benchmark answers respectively in association with the plurality of portions of text data.

Block 506: The processor evaluates a plurality of operating LLMs. For each candidate operating LLM, the processor executes the following operations in blocks 508 to 512.

Block 508: The processor inputs the plurality of benchmark questions and the plurality of portions of text data into the candidate operating LLM to compute a plurality of comparative answers that respectively correspond to the plurality of benchmark questions and respectively correspond to the plurality of portions of text data.

Block 510: The processor, for each one of the plurality of benchmark questions, compares a respective benchmark answer from amongst the plurality of benchmark answers and a respective comparative answer from amongst the plurality of comparative answers to output a correctness value.

Block 512: The processor computes and outputs an accuracy score of the candidate operating LLM based on a combination of a plurality of correctness values associated with the plurality of benchmark questions.

After evaluating all the operating LLMs, there are a plurality of accuracy scores respectively associated with the plurality of operating LLMs.

Block 514: The processor identifies a given operating LLM with a highest accuracy score from amongst the plurality of operating LLMs.

In some cases, the processor automatically integrates the operating LLM.

Block 516: The processor automatically integrates the given operating LLM into the interactive chat application.

In some cases, the plurality of portions of text data (also called chunks) are from a group of documents. These documents are sometimes also called articles. In some cases, these documents associated with an interactive chat knowledge application. For example, the interactive chat knowledge application is specific to a topic or a range of topics, and the documents are relevant to the topic or the range of topics.

In some cases, when the operating LLM has been automatically integrated into the interactive chat knowledge application, the processor is further configured to at least: receive a user-inputted question via the chatbot UI 156, and process the user-inputted question using the operating LLM to output a response derived from one or more documents from the group of documents. The processor also then displays, via the chatbot UI 156, the response and one or more citations corresponding to the one or more documents. In some cases, the one or more citations are data links that, when selected by user, display the relevant document.

In some cases, the benchmark LLM is larger than the operating LLM. In cases in which a plurality of operating LLMs are evaluates, each of the plurality of operating LLMs are smaller than the benchmark LLM.

In some cases, the comparator LLM 146 is the benchmark LLM 142. In some other cases, the comparator LLM 142 is a separate LLM from the benchmark LLM 142 that specializes in comparing the respective benchmark answer from amongst the plurality of benchmark answers and the respective comparative answer from amongst the plurality of comparative answers to output the plurality of correctness values. In some cases, the correctness value is one of a correct value or an incorrect value, and the accuracy score is computed by: a number of correct values divided by a number of the plurality of benchmark questions.

Various systems or processes have been described to provide examples of embodiments of the claimed subject matter. No such example embodiment described limits any claim and any claim may cover processes or systems that differ from those described. The claims are not limited to systems or processes having all the features of any one system or process described above or to features common to multiple or all the systems or processes described above. It is possible that a system or process described above is not an embodiment of any exclusive right granted by issuance of this patent application. Any subject matter described above and for which an exclusive right is not granted by issuance of this patent application may be the subject matter of another protective instrument, for example, a continuing patent application, and the applicants, inventors or owners do not intend to abandon, disclaim or dedicate to the public any such subject matter by its disclosure in this document.

For simplicity and clarity of illustration, reference numerals may be repeated among the figures to indicate corresponding or analogous elements. In addition, numerous specific details are set forth to provide a thorough understanding of the subject matter described herein. However, it will be understood by those of ordinary skill in the art that the subject matter described herein may be practiced without these specific details. In other instances, well-known methods, procedures, and components have not been described in detail so as not to obscure the subject matter described herein.

The terms “coupled” or “coupling” as used herein can have several different meanings depending in the context in which these terms are used. For example, the terms coupled or coupling can have a mechanical, electrical or communicative connotation. For example, as used herein, the terms coupled or coupling can indicate that two elements or devices are directly connected to one another or connected to one another through one or more intermediate elements or devices via an electrical element, electrical signal, or a mechanical element depending on the particular context. Furthermore, the term “operatively coupled” may be used to indicate that an element or device can electrically, optically, or wirelessly send data to another element or device as well as receive data from another element or device.

As used herein, the wording “and/or” is intended to represent an inclusive-or. That is, “X and/or Y” is intended to mean X or Y or both, for example. As a further example, “X, Y, and/or Z” is intended to mean X or Y or Z or any combination thereof.

Terms of degree such as “substantially”, “about”, and “approximately” as used herein mean a reasonable amount of deviation of the modified term such that the result is not significantly changed. These terms of degree may also be construed as including a deviation of the modified term if this deviation would not negate the meaning of the term it modifies.

Any recitation of numerical ranges by endpoints herein includes all numbers and fractions subsumed within that range (e.g., 1 to 5 includes 1, 1.5, 2, 2.75, 3, 3.90, 4, and 5). It is also to be understood that all numbers and fractions thereof are presumed to be modified by the term “about” which means a variation of up to a certain amount of the number to which reference is being made if the result is not significantly changed.

Some elements herein may be identified by a part number, which is composed of a base number followed by an alphabetical or subscript-numerical suffix (e.g. 112a, or 112b). All elements with a common base number may be referred to collectively or generically using the base number without a suffix (e.g., 112).

The systems and methods described herein may be implemented as a combination of hardware or software. In some cases, the systems and methods described herein may be implemented, at least in part, by using one or more computer programs, executing on one or more programmable devices including at least one processing element, and a data storage element (including volatile and non-volatile memory and/or storage elements). These systems may also have at least one input device (e.g. a pushbutton keyboard, mouse, a touchscreen, and the like), and at least one output device (e.g. a display screen, a printer, a wireless radio, and the like) depending on the nature of the device. Further, in some examples, one or more of the systems and methods described herein may be implemented in or as part of a distributed or cloud-based computing system having multiple computing components distributed across a computing network. For example, the distributed or cloud-based computing system may correspond to a private distributed or cloud-based computing cluster that is associated with an organization. Additionally, or alternatively, the distributed or cloud-based computing system be a publicly accessible, distributed or cloud-based computing cluster, such as a computing cluster maintained by Microsoft Azure™, Amazon Web Services™, Google Cloud™, or another third-party provider. In some instances, the distributed computing components of the distributed or cloud-based computing system may be configured to implement one or more parallelized, fault-tolerant distributed computing and analytical processes, such as processes provisioned by an Apache Spark™ distributed, cluster-computing framework or a Databricks ™ analytical platform. Further, and in addition to the CPUs described herein, the distributed computing components may also include one or more graphics processing units (GPUs) capable of processing thousands of operations (e.g., vector operations) in a single clock cycle, and additionally, or alternatively, one or more tensor processing units (TPUs) capable of processing hundreds of thousands of operations (e.g., matrix operations) in a single clock cycle.

Some elements that are used to implement at least part of the systems, methods, and devices described herein may be implemented via software that is written in a high-level procedural language such as object-oriented programming language. Accordingly, the program code may be written in any suitable programming language such as Python or Java, for example. Alternatively, or in addition thereto, some of these elements implemented via software may be written in assembly language, machine language or firmware as needed. In either case, the language may be a compiled or interpreted language.

At least some of these software programs may be stored on a storage media (e.g., a computer readable medium such as, but not limited to, read-only memory, magnetic disk, optical disc) or a device that is readable by a general or special purpose programmable device. The software program code, when read by the programmable device, configures the programmable device to operate in a new, specific, and predefined manner to perform at least one of the methods described herein.

Furthermore, at least some of the programs associated with the systems and methods described herein may be capable of being distributed in a computer program product including a computer readable medium that bears computer usable instructions for one or more processors. The medium may be provided in various forms, including non-transitory forms such as, but not limited to, one or more diskettes, compact disks, tapes, chips, and magnetic and electronic storage. Alternatively, the medium may be transitory in nature such as, but not limited to, wire-line transmissions, satellite transmissions, internet transmissions (e.g., downloads), media, digital and analog signals, and the like. The computer usable instructions may also be in various formats, including compiled and non-compiled code.

While the above description provides examples of one or more processes or systems, it will be appreciated that other processes or systems may be within the scope of the accompanying claims.

To the extent any amendments, characterizations, or other assertions previously made (in this or in any related patent applications or patents, including any parent, sibling, or child) with respect to any art, prior or otherwise, could be construed as a disclaimer of any subject matter supported by the present disclosure of this application, Applicant hereby rescinds and retracts such disclaimer. Applicant also respectfully submits that any prior art previously considered in any related patent applications or patents, including any parent, sibling, or child, may need to be revisited.

What is claimed is:

1. A server system for evaluating an operating large language model (LLM), the server system comprising:
a memory storing at least a benchmark LLM and the operating LLM, a network interface, and a processor, the processor operably coupled to the memory and the network interface, the processor configured to:
obtain a plurality of portions of text data;
use the benchmark LLM to compute at least one benchmark question and one benchmark answer per portion of text data from amongst the plurality of portions of text data, and store a plurality of benchmark questions and a plurality of benchmark answers respectively in association with the plurality of portions of text data;
input the plurality of benchmark questions and the plurality of portions of text data into the operating LLM to compute a plurality of comparative answers that respectively correspond to the plurality of benchmark questions and respectively correspond to the plurality of portions of text data;
for each one of the plurality of benchmark questions, compare a respective benchmark answer from amongst the plurality of benchmark answers and a respective comparative answer from amongst the plurality of comparative answers to output a correctness value; and
compute and output an accuracy score of the operating LLM based on a combination of a plurality of correctness values associated with the plurality of benchmark questions.

2. The server system of claim 1, wherein the plurality of portions of text data are from a group of documents, and the group of documents is associated with an interactive chat knowledge application.

3. The server system of claim 2, wherein, after determining that the accuracy score of the operating LLM is above a threshold score, automatically integrating the operating LLM in the interactive chat knowledge application; and wherein the interactive chat knowledge application comprises: a chatbot user interface, the operating LLM, and a database comprising the group of documents.

4. The server system of claim 3, wherein, when the operating LLM has been automatically integrated into the interactive chat knowledge application, the processor is further configured to at least: receive a user-inputted question via the chatbot user interface; process the user-inputted question using the operating LLM to output a response derived from one or more documents from the group of documents; and display, via the chatbot interface, the response and one or more citations corresponding to the one or more documents.

5. The server system of claim 2, wherein a plurality of operating LLMs are automatically evaluated against the benchmark LLM, and the processor is further configured to at least: identify a given operating LLM with a highest accuracy score from amongst the plurality of operating LLMs, and automatically integrate the given operating LLM into the interactive chat knowledge application; and
wherein the interactive chat knowledge application comprises: a chatbot user interface, the operating LLM, and a database comprising the group of documents.

6. The server system of claim 1, wherein the benchmark LLM has a higher number of parameters than the operating LLM.

7. The server system of claim 1, wherein a comparator LLM is used to compare the respective benchmark answer from amongst the plurality of benchmark answers and the respective comparative answer from amongst the plurality of comparative answers to output the plurality of correctness values.

8. The server system of claim 7, wherein the comparator LLM is the benchmark LLM.

9. The server system of claim 7, wherein the comparator LLM is a secondary benchmark LLM that is more accurate than the operating LLM.

10. The server system of claim 1, wherein the correctness value is a correct value or an incorrect value, and the accuracy score is computed by: a number of correct values divided by a number of the plurality of benchmark questions.

11. A method for evaluating an operating large language model (LLM), the method executed in a computing environment comprising one or more processors and memory, wherein the memory stores at least a benchmark LLM and the operating LLM, and the method comprising:
obtaining a plurality of portions of text data;
using the benchmark LLM to compute at least one benchmark question and one benchmark answer per portion of text data from amongst the plurality of portions of text data, and storing a plurality of benchmark questions and a plurality of benchmark answers respectively in association with the plurality of portions of text data;
inputting the plurality of benchmark questions and the plurality of portions of text data into the operating LLM to compute a plurality of comparative answers that respectively correspond to the plurality of benchmark questions and respectively correspond to the plurality of portions of text data;
for each one of the plurality of benchmark questions, comparing a respective benchmark answer from amongst the plurality of benchmark answers and a respective comparative answer from amongst the plurality of comparative answers to output a correctness value; and
computing and outputting an accuracy score of the operating LLM based on a combination of a plurality of correctness values associated with the plurality of benchmark questions.

12. The method of claim 11, wherein the plurality of portions of text data are from a group of documents, and the group of documents is associated with an interactive chat knowledge application.

13. The method of claim 12, wherein, after determining that the accuracy score of the operating LLM is above a threshold score, automatically integrating the operating LLM in the interactive chat knowledge application; and wherein the interactive chat knowledge application comprises: a chatbot user interface, the operating LLM, and a database comprising the group of documents.

14. The method of claim 13, wherein, when the operating LLM has been automatically integrated into the interactive chat knowledge application, the method further comprising: receiving a user-inputted question via the chatbot user interface; processing the user-inputted question using the operating LLM to output a response derived from one or more documents from the group of documents; and displaying, via the chatbot interface, the response and one or more citations corresponding to the one or more documents.

15. The method of claim 12, wherein a plurality of operating LLMs are automatically evaluated against the benchmark LLM, and the method further comprising: identifying a given operating LLM with a highest accuracy score from amongst the plurality of operating LLMs, and automatically integrating the given operating LLM into the interactive chat knowledge application; and
wherein the interactive chat knowledge application comprises: a chatbot user interface, the operating LLM, and a database comprising the group of documents.

16. The method of claim 11, wherein the benchmark LLM has a higher number of parameters than the operating LLM.

17. The method of claim 11, wherein a comparator LLM is used to compare the respective benchmark answer from amongst the plurality of benchmark answers and the respective comparative answer from amongst the plurality of comparative answers to output the plurality of correctness values.

18. The method of claim 17, wherein the comparator LLM is a secondary benchmark LLM that is more accurate than the operating LLM.

19. The method of claim 11, wherein the correctness value is a correct value or an incorrect value, and the accuracy score is computed by: a number of correct values divided by a number of the plurality of benchmark questions.

20. A non-transitory computer readable medium storing computer executable instructions which, when executed by at least one computer processor, cause the at least one computer processor to carry out a method for evaluating an operating large language model (LLM), the non-transitory computer readable medium further comprising at least a benchmark LLM and the operating LLM, and the method comprising:
obtaining a plurality of portions of text data;
using the benchmark LLM to compute at least one benchmark question and one benchmark answer per portion of text data from amongst the plurality of portions of text data, and storing a plurality of benchmark questions and a plurality of benchmark answers respectively in association with the plurality of portions of text data;
inputting the plurality of benchmark questions and the plurality of portions of text data into the operating LLM to compute a plurality of comparative answers that respectively correspond to the plurality of benchmark questions and respectively correspond to the plurality of portions of text data;
for each one of the plurality of benchmark questions, comparing a respective benchmark answer from amongst the plurality of benchmark answers and a respective comparative answer from amongst the plurality of comparative answers to output a correctness value; and
computing and outputting an accuracy score of the operating LLM based on a combination of a plurality of correctness values associated with the plurality of benchmark questions.
